(19) United States
(12) Patent Application Publication
(10) Pub. No.: US 2025/0225904 A1
(43) Pub. Date: Jul. 10, 2025

(54) DISPLAY DEVICE FOR IMPROVING METAMERISM AND CONTROL METHOD THEREFOR

(71) Applicant: SAMSUNG ELECTRONICS CO., LTD., Suwon-si (KR)

(72) Inventors: Jiman KIM, Suwon-si (KR); Dukjin KANG, Suwon-si (KR); Ohyun KWON, Suwon-si (KR); Sehyeok PARK, Suwon-si (KR); Sungwon SEO, Suwon-si (KR); Mirae SHIN, Suwon-si (KR); Seongwoon JUNG, Suwon-si (KR); Hyeyoung JUNG, Suwon-si (KR); Taehwan CHA, Suwon-si (KR); Bonseuk GOO, Suwon-si (KR); Kyungsoo PARK, Suwon-si (KR); Byungseok SOH, Suwon-si (KR); Jinho SON, Suwon-si (KR); Weonhee LEE, Suwon-si (KR); Huiman LEE, Suwon-si (KR); Juae CHAE, Suwon-si (KR); Hangjin CHOI, Suwon-si (KR)

(73) Assignee: SAMSUNG ELECTRONICS CO., LTD., Suwon-si (KR)

(21) Appl. No.: 19/089,820

(22) Filed: Mar. 25, 2025

Related U.S. Application Data
(63) Continuation of application No. PCT/KR2023/011605, filed on Aug. 7, 2023.

(30) Foreign Application Priority Data
Sep. 29, 2022 (KR) 10-2022-0124627
Nov. 28, 2022 (KR) 10-2022-0161872

(51) Int. Cl. G09G 3/20; G01J 3/50

(52) U.S. Cl. CPC G09G 3/2003; G01J 3/506; G09G 2320/0666; G09G 2320/0693

(57) ABSTRACT

A display device includes: a communication interface; a display; and at least one processor connected to the communication interface and the display, and configured to control the display device, where the at least one processor is configured to: based on a first color matching function (CMF) corresponding to the display device, a second CMF, and a target spectrum corresponding to the display device, obtain a second measurement value from a RGB combination ratio of a standard spectrum based on a first measurement value; control the display to display a preset color; receive a third measurement value from a measuring instrument of the second CMF for the preset color through the communication interface; and calibrate the display based on the second measurement value and the third measurement value, and where the first measurement value is a value for the preset color displayed on a second display device.

### CROSS-REFERENCE TO RELATED APPLICATION(S)

This application is a continuation of International Application No. PCT/KR2023/011605, filed on Aug. 7, 2023, in the Korean Intellectual Property Receiving Office, which is based on and claims priority to Korean Patent Applications No. 10-2022-0124627, filed on Sep. 29, 2022 and No. 10-2022-0161872, filed on Nov. 28, 2022, in the Korean Intellectual Property Office, the disclosures of which are incorporated by reference herein in their entireties.

### BACKGROUND

### 1. Field

The present disclosure relates to a display device and a control method therefor and more particularly, to a display device improving metamerism and a control method therefor.

### 2. Description of Related Art

In general, a display may mix three primary colors of red, green, and blue (RGB) in proper intensity to express various colors. A spectrum of a color of a real object is different from that of a color of a display, but the colors may be made as the same visual information in human eyes. In this case, a person may recognize that the color of the real object is the same as the color of an image and this phenomenon is referred to as metamerism.

Meanwhile, a recent color space such as BT.2020 has been redefined to express a wide color gamut which is wider than the existing color gamut, wherein in order to implement the above, various displays capable of expressing the wide color gamut are being developed.

In order for the display to express the wide color gamut, each RGB spectrum may have a characteristic of an increasingly-narrow band spectrum, and the narrow band spectrum may make a difference in cone cell characteristics between observers more apparent, which may deteriorate the representativeness of a standard observer of the existing tristimulus value function (legacy, Commission Internationale de l'Eclairage (CIE) 1931).

Also, in spite of a recent trend of increasing wide color gamut displays having various optical structures deviating from the existing cathode ray tube (CRT) and cold cathode fluorescent lamp (CCFL), there is a lack of a transmission method or an application method of calibration data for resolving metamerism of the display.

In particular, although a measurement value in accordance with a criterion of CIE 1931, which is generally used is transmitted between displays, the corresponding measurement value alone may not allow color matching between displays having completely different types of light sources.

Even if a tristimulus value by which perceptual matching is possible is transmitted together, most measuring instruments may perform measurement only in a legacy method (CIE 1931), and thus there is no way to apply the same.

### SUMMARY

Provided is a display device for improving transmission of a color measurement value between heterogeneous displays and metamerism and a control method therefor.

Additional aspects will be set forth in part in the description which follows and, in part, will be apparent from the description, or may be learned by practice of the presented embodiments.

According to an aspect of an embodiment, a display device may include: a communication interface; a display; and at least one processor connected to the communication interface and the display, and configured to control the display device, where the at least one processor is configured to: based on a first color matching function (CMF) corresponding to the display device, a second CMF, and a target spectrum corresponding to the display device, obtain a second measurement value from a RGB combination ratio of a standard spectrum based on a first measurement value; control the display to display a preset color; receive a third measurement value from a measuring instrument of the second CMF for the preset color through the communication interface; and calibrate the display based on the second measurement value and the third measurement value, and where the first measurement value is a value for the preset color displayed on a second display device.

The at least one processor may be further configured to: based on a difference between the second measurement value and the third measurement value being equal to or greater than a preset value, perform the calibration based on the second measurement value and the third measurement value; and based on the difference between the second measurement value and the third measurement value being less than the preset value, terminate the calibration.

The at least one processor may be further configured to repeat the calibration based on a plurality of preset colors.

The RGB combination ratio of the standard spectrum may be based on the first measurement value, a third CMF corresponding to the second display device, and the standard spectrum.

The at least one processor may be further configured to: receive a fourth measurement value based on the first measurement value from the second display device or a server through the communication interface; and obtain a RGB combination ratio of the standard spectrum based on the fourth measurement value and the second CMF.

The fourth measurement value may be based on the RGB combination ratio of the standard spectrum and the second CMF.

The at least one processor may be further configured to: receive a RGB combination ratio of the standard spectrum from the second display device or a server through the communication interface.

The at least one processor may be further configured to: obtain a fifth measurement value based on the RGB combination ratio of the standard spectrum and the first CMF; obtain a RGB combination ratio of the target spectrum based on the fifth measurement value and the target spectrum; and obtain the second measurement value based on the RGB combination ratio of the target spectrum and the second CMF.

The measuring instrument of the second CMF may be based on a Commission Internationale de I'Eclairage (CIE) 1931 measurement method.

The standard spectrum may have a color gamut wider than a color gamut of the target spectrum.

According to an aspect of an embodiment, a method of controlling a display device may include: based on a first CMF corresponding to the display device, a second CMF, and a target spectrum corresponding to the display device, obtaining a second measurement value from a RGB combination ratio of a standard spectrum based on a first measurement value; displaying a preset color though a display of the display device; receiving a third measurement value from a measuring instrument of the second CMF for the preset color; and calibrating the display based on the second measurement value and the third measurement value, where the first measurement value is a value for the preset color displayed on a second display device.

The calibrating may include: based on a difference between the second measurement value and the third measurement value being equal to or greater than a preset value, performing the calibration based on the second measurement value and the third measurement value; and based on the difference between the second measurement value and the third measurement value being less than the preset value, terminating the calibration.

The method may further include repeating the calibration based on a plurality of preset colors.

The RGB combination ratio of the standard spectrum may be based on the first measurement value, a third CMF corresponding to the second display device, and the standard spectrum.

The method may further include: receiving a fourth measurement value based on the first measurement value from the second display device or a server; and obtaining a RGB combination ratio of the standard spectrum based on the fourth measurement value and the second CMF.

Also, the fourth measurement value may be obtained based on the RGB combination ratio of the standard spectrum and the second CMF.

Further, the method may further include receiving the RGB combination ratio of the standard spectrum from the second display device or a server.

Also, the obtaining the second measurement value may include obtaining a fifth measurement value based on the RGB combination ratio of the standard spectrum and the first CMF, obtaining a RGB combination ratio of the target spectrum based on the fifth measurement value and the target spectrum, and obtaining the second measurement value based on the RGB combination ratio of the target spectrum and the second CMF.

Further, the measuring instrument of the second CMF may be a measuring instrument using a Commission Internationale de l'Eclairage (CIE) 1931 measurement method.

Also, the standard spectrum may have a color gamut wider than that of the target spectrum.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a view illustrating metamerism to help understanding of one or more embodiments of the disclosure;

FIG. 2 is a block diagram illustrating a configuration of a display system according to an embodiment;

FIG. 3 is a block diagram illustrating a configuration of a display device according to an embodiment;

FIG. 4 is a block diagram illustrating a detailed configuration of a display device according to an embodiment;

FIG. 5 is a sequence diagram illustrating a method of transmitting a measurement value according to an embodiment;

FIG. 6, FIG. 7, FIG. 8, FIG. 9, FIG. 10, FIG. 11, FIG. 12, and FIG. 13 are views illustrating each stage of conversion of a measurement value according to one or more embodiments;

FIG. 14 is a view illustrating a method of obtaining a conversion matrix according to an embodiment;

FIG. 15 is a view illustrating a method of obtaining a RGB combination ratio of a standard spectrum according to an embodiment; and

FIG. 16 is a flow chart illustrating a method of controlling a display device according to an embodiment.

### DETAILED DESCRIPTION

The disclosure is described with reference to the appended drawings hereinafter.

The terms used in embodiments of the disclosure are selected as general terms which are currently widely used as much as possible in consideration of functions in the disclosure but may be varied depending on intention of those skilled in the art, a precedent, appearance of new technologies, or the like. Also, there is a term which is arbitrarily selected by the applicant in a certain case and in this case, its meaning will be specifically described in the relevant description part of the disclosure. Therefore, the term used in the disclosure should be defined based on the meaning of the term and the entire content throughout the disclosure rather than the simple name of the term.

In the specification, the expression such as “have”, “may have”, “include”, or “may include” denotes the existence of such a characteristic (e.g. a numerical value, a function, an operation, or a component such as a part) and does not exclude the existence of additional characteristics.

The expression “at least one of A and/or B” should be interpreted to mean any one of “A” or “B” or “A and B”.

The expression “1st”, “2nd”, “first”, “second”, or the like used in the specification may be used to describe various elements regardless of any order and/or degree of importance, wherein such expression is used only to distinguish one element from another element and is not intended to limit the relevant element.

A singular expression includes a plural expression, unless obviously differently defined in the context. In the application, the term such as “have”, “comprise”, “include”, “consist of”, or the like should be construed as designating that there are such characteristics, numbers, steps, operations, components, parts, or a combination thereof described in the specification but not as excluding in advance possibility of the existence or addition of one or more other characteristics, numbers, steps, operations, components, parts, or a combination thereof.

In the disclosure, the term “user” may be referred to as a person who uses an electronic device or a device which uses the electronic device (e.g. an artificial intelligence (AI) electronic device).

Hereinafter, various embodiments of the disclosure are more specifically described with reference to the appended drawings.

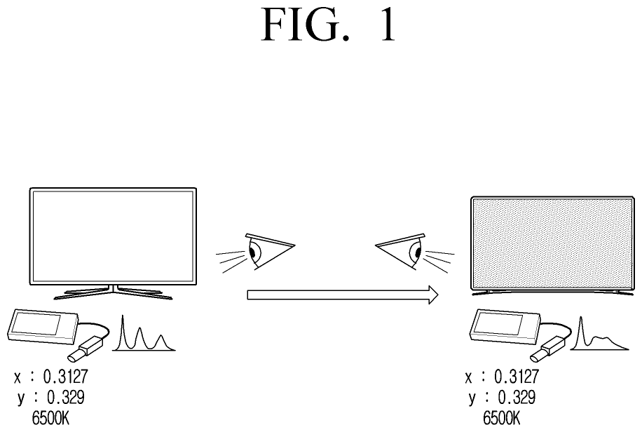

FIG. 1 is a view illustrating metamerism to help understanding of the disclosure.

As shown in FIG. 1, if a driving method (a light source) between displays is different, even if calibration is performed based on the same color coordinate through a measuring instrument, colors of the display maybe be differently viewed by human eyes.

Metamerism may mean that in spite of different spectra, if the same visual information is made in human eyes, colors are identically recognized. Hereinafter, the metamerism is described to mean a phenomenon that even if a tristimulus value XYZ is the same, colors are differently recognized because of a difference of optical spectra between the displays.

Therefore, there is a need for developing a method for transmitting a color measurement value between displays having different driving methods (light sources).

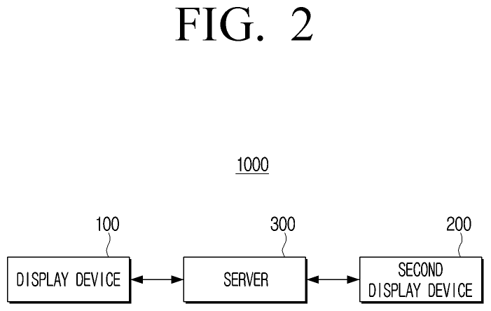

FIG. 2 is a block diagram illustrating a configuration of a display system 1000 according to an embodiment. As shown in FIG. 2, the display system 1000 includes a display device 100, a second display device 200, and a server 300.

The display device 100 is a device calibrating a display included in the display device 100 to correspond to the second display device 200 and may be a TV, a desktop PC, a laptop, a smart phone, a tablet PC, smart glasses, a smart watch, etc.

The display device 100 may calibrate the display based on a value obtained by a measuring instrument of a legacy CMF (identical to a second CMF) measuring a preset color displayed on the second display device 200. Here, the CMF is a function used for converting a wavelength to a color (a numeral value such as RGB or XYZ), wherein the display device passes the wavelength through the relevant function to convert the wavelength to three numeral values, and the numeralized color values may be a value in which a standard observer expresses recognition as an objective numerical value when viewing a color (a wavelength). The measuring instrument of the legacy CMF may be a measuring instrument using a CIE 1931 measurement method. The CIE 1931 is one of initial color spaces mathematically defined based on a study on color recognition of a human and is expressed with XYZ. The color space represents a mathematical model correlating each color with three stimulus values, wherein CIE XYZ among various color spaces is made by directly measuring color recognition of the human.

The second display device 200 is a device displaying a preset color and converting a value obtained by a measurement instrument of the legacy CMF measuring the preset color, wherein it may be a device having a display such as a TV, a desktop PC, a laptop, a smart phone, a tablet PC, a smart glasses, or a smart watch.

For example, the second display device 200 may display a preset color, convert a value obtained by the measuring instrument of the legacy CMF measuring the preset color based on a CMF corresponding to the second display device 200, and transmit the converted value to the server 300.

The server 200 may reconvert the converted value received from the second display device 200 based on the legacy CMF and a standard spectrum and may transmit the reconverted value to the display device 100. Here, a color gamut of the standard spectrum may be wider than that of a target spectrum corresponding to the display device 100 to be after-mentioned.

The display device 100 may obtain a final value by converting the reconverted value to a CMF corresponding to the display device 100 and a target spectrum corresponding to the display device 100.

The display device 100 may display the preset color, compare a value obtained by the measuring instrument of the legacy CMF measuring the preset color and the final value, and perform calibration with respect to the display.

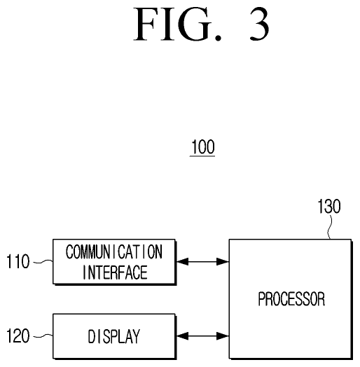

FIG. 3 is a block diagram illustrating a configuration of a display device 100 according to an embodiment.

According to FIG. 3, the display device 100 includes a communication interface 110, a display 120, and a processor 130.

The communication interface 110 is a component performing communication with various types of external devices according to various types of communication methods. For example, the display device 100 may perform communication with the display device 200 or a server 300 through the communication interface 110.

The communication interface 110 may include a Wi-Fi module, a Bluetooth module, an infrared communication module, a wireless communication module, etc. Here, each communication module may be implemented in a form of at least one hardware chip.

The Wi-Fi module and the Bluetooth module perform communication in a Wi-Fi method and a Bluetooth method, respectively. In case of using the Wi-Fi module or the Bluetooth module, the module may receive and transmit various connection information such as a SSID and a session key in advance, connect communication by using the connection information, and then receive and transmit various information. The infrared communication module may perform communication based on an infrared data association (IrDA) technology which transmits data wirelessly in a short distance by using infrared light between visible light and a millimeter wave.

The wireless communication module may include at least one communication chip performing communication according to various wireless communication standards such as Zigbee, a 3rd generation (3G), a 3rd generation partnership project (3GPP), long term evolution (LTE), LTE Advanced (LTE-A), a 4th generation (4G), and a 5th generation (5G).

Otherwise, the communication interface 110 may include a wired communication interface such as a HDMI, DP, Thunderbolt, a USB, RGB, a D-SUB, a DVI, or the like.

Besides, the communication interface 110 may include at least one of a local area network (LAN) module, an Ethernet module, or a wired communication module performing communication by using a pair cable, a coaxial cable, a fiber optic cable, or the like.

The display 120 is a component displaying an image and may be implemented as displays having various forms such as a liquid crystal display (LCD), an organic light emitting diode (OLED) display, and a plasma display panel (PDP). The display 120 may include a driving circuit which may be implemented in a form such as an a-si TFT, a low temperature poly silicon (LTPS) TFT, or an organic TFT (OTFT), a backlight unit, or the like therein. Meanwhile, the display 120 may be implemented as a touch screen coupled to a touch sensor, a flexible display, a 3D display, or the like.

The processor 130 controls operations of the display device 100 overall. Specifically, the processor 130 may be connected to each component of the display device 100 to control operations of the display device 100 overall. For example, the processor 130 may be connected to a component such as the communication interface 110, the display 120, memory, or the like to control operations of the display device 100.

At least one processor 130 may include one or more of a CPU, a Graphics Processing Unit (GPU), an Accelerated Processing Unit (APU), a Many Integrated Core (MIC), a Neural Processing Unit (NPU), a hardware accelerator, or a machine learning accelerator. The at least one processor 130 may control one or any combination of other components of the display device 100 and perform an operation related to communication or data processing. The at least one processor 130 may perform one or more programs or instructions stored in the memory. For example, the at least one processor 130 may perform a method according to an embodiment of the disclosure by executing one or more instructions stored in the memory.

If a method according to an embodiment of the disclosure includes a plurality of operations, the plurality of operations may be performed by one processor and may be performed by a plurality of processors. For example, when a first operation, a second operation, and a third operation are performed by a method according to an embodiment, all of the first operation, the second operation, and the third operation may be performed by a first processor and also, the first operation and the second operation are performed by the first processor (e.g. a general purpose processor) and the third operation may be performed by a second processor (e.g. an Artificial Intelligence (AI)-dedicated processor).

The at least one processor 130 may be implemented as a single core processor including one core and may be implemented as one or more multi core processors including a plurality of cores (e.g. homogeneous multicores or heterogeneous multicores). If the at least one processor 130 is implemented as a multi core processor, each of the plurality of cores included in the multi core processor may include processor internal memory such as cache memory and on-chip memory, wherein a common cache shared by the plurality of cores may be included in the multi core processor. Also, each of the plurality of cores included in the multi core processor (or part of the plurality of cores) may read and perform program instructions for independently implementing a method according to an embodiment of the disclosure and also, may read and perform program instructions for implementing a method according to an embodiment of the disclosure in connection with all (or part) of the plurality of cores.

If a method according to an embodiment of the disclosure includes a plurality of operations, the plurality of operations may be performed by one core among the plurality of cores included in the multi core processor and may be performed by the plurality of cores. For example, when a first operation, a second operation, and a third operation are performed by a method according to an embodiment, all of the first operation, the second operation, and the third operation may be performed by a first core included in the multi core processor and also, the first operation and the second operation may be performed by the first core included in the multi core processor and the third operation may be performed by the second core included in the multi core processor.

In embodiments of the disclosure, at least one processor 130 may mean a System on Chip (SoC) onto which one or more processors and other electronic components are integrated, a single core processor, a multi core processor, or a core included in the single core processor or the multi core processor, wherein the core may be implemented as a CPU, a GPU, an APU, a MIC, a NPU, a hardware accelerator, or a machine learning accelerator, but embodiments of the disclosure are not limited thereto. Meanwhile, hereinafter, for convenience of the description, operations of the display device 100 are described based on the expression “processor 130”.

The processor 130 may obtain a second measuring value from a RGB combination ratio of the standard spectrum based on a first measurement value based on a target CMF (identical to a first CMF) corresponding to the display device 100, a legacy CMF, and a target spectrum corresponding to the display device 100. Here, the first measurement value may be a value obtained by the measuring instrument of the legacy CMF measuring the preset color displayed on the second display device 200.

The RGB combination ratio of the standard spectrum may be obtained by the processor 130 from different information or may be received from the second display device 200 or the server 300.

For example, the RGB combination ratio of the standard spectrum may be obtained from a first measurement value based on a reference CMF (identical to a third CMF) corresponding to the second display device 200 and the standard spectrum. In this case, the processor 130 may receive a fourth measurement value based on the first measurement value from the second display device 200 or the server 300 through the communication interface 110 and obtain a RGB combination ratio of the standard spectrum based on the fourth measurement value and the legacy CMF. Here, a fourth measurement value may be obtained based on a RGB combination ratio of the standard spectrum and the legacy CMF, wherein if it is processed in the second display device 200, the second display device 200 may provide the fourth measurement value to the display device 100, and if it is processed in the server 300, the server 300 may provide the fourth measurement value to the display device 100. A processing subject of the fourth measurement value may be various according to an implementation method.

Otherwise, the processor 130 may receive a RGB combination ratio of the standard spectrum from the second display device 200 or the server 300 through the communication interface 110. In this case, a partial conversion operation may be omitted but it may be difficult to implement it in the conventional display device which may not process the RGB combination ratio of the standard spectrum. In this case, there is a need for conversion to the aforementioned fourth measurement value.

The processor 130 may obtain a fifth measurement value based on the RGB combination ratio of the standard spectrum and the target CMF, obtain a RGB combination ratio of the target spectrum based on the fifth measurement value and the target spectrum, and obtain the second measurement value based on the RGB combination ratio of the target spectrum and the legacy CMF.

An operation of converting the measurement value is specifically after-mentioned through the drawings.

The processor 130 may control the display 120 to display a preset color, receive a third measurement value obtained by the measuring instrument of the legacy CMF measuring the preset color from the measuring instrument through the communication interface 110, and may calibrate the display 120 based on the second measurement value and the third measurement value.

For example, the display device 100 may further include a RGB gain adjusting circuit, and the processor 130 may control the RGB gain adjusting circuit to calibrate the display 120.

The processor 130, if a difference between the second measurement value and the third measurement value is equal to or greater than a preset value, may perform the calibration based on the second measurement value and the third measurement value, and if the difference between the second measurement value and the third measurement value is less than the preset value, terminate the calibration. That is, the processor 130, if the difference between the second measurement value and the third measurement value is equal to or greater than the preset value, may control the display 120 to display the preset color. The processor 130 may receive a third measurement value obtained by the measuring instrument of the legacy CMF remeasuring the preset color from the measuring instrument through the communication interface 110 and recompare the second measurement value and the remeasured third measurement value. The processor 130 may repeat the above process until the difference between the second measurement value and the third measurement value is less than the preset value.

Meanwhile, the calibration with respect to the preset color was described as above, but the processor 130 may perform the above operation with an additional color. That is, the processor 130 may repeat the calibration based on a plurality of preset colors. For example, the processor 130 may perform the above calibration with respect to a color of R. Here, not only the display device 100 but also the second display device 200 may display the color of R. If calibration with respect to the color of R is completed, the display device 100 and the second display device 200 may display a color of G and the processor 130 may perform calibration with respect to the color of G. The processor 130 may perform calibration with respect to colors of W and B.

Meanwhile, the disclosure is not limited thereto, and the processor 130 may perform calibration only with respect to part of colors of W, R, G, and B. Otherwise, the processor 130 may perform calibration with respect to not only the colors of W, R, G, and B but also an additional color.

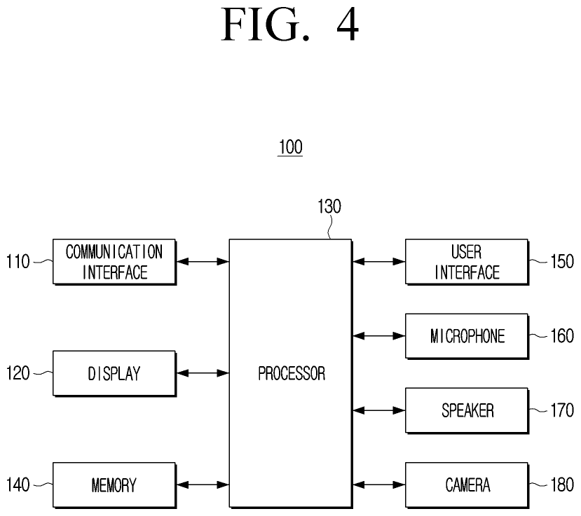

FIG. 4 is a block diagram illustrating a detailed configuration of a display device 100 according to an embodiment. The display device 100 may include the communication interface 110, the display 120, and the processor 130. Also, according to FIG. 4, the display device 100 may further include memory 140, a user interface 140, a microphone 160, a speaker 170, and a camera 180. The detailed description of components overlapped with the components shown in FIG. 3 among the components shown in FIG. 4 is omitted.

The memory 140 may refer to hardware storing information such as data in an electric form or a magnetic form in order that the processor 130 or the like may access thereto. For the above, the memory 140 may be implemented as at least one hardware of non-volatile memory, volatile memory, flash memory, a hard disk drive (HDD) or a solid state drive (SDD), RAM, or ROM.

The memory 140 may store at least one instruction required for an operation of the display device 100 or the processor 130. Here, the instruction may be written in a machine language, which is a computer-understandable language as a code unit instructing an operation of the display device 100 or the processor 130. Otherwise, the memory 140 may store a plurality of instructions performing specific work of the display device 100 or the processor 130 as an instruction set.

The memory 140 may store data which is information in a bit or bite unit indicating a character, a number, an image, or the like. For example, the memory 140 may store information about a target CMF, a legacy CMF, a target spectrum, a standard spectrum, etc.

The memory 140 may be accessed by the processor 130, wherein the processor 130 may perform reading/recording/correcting/deleting/renewing, or the like with respect to the instructions, the instruction set, or data.

The user interface 150 may be implemented as a button, a touch pad, a mouse, a keyboard, or the like or may be also implemented as a touch screen which may perform the display function and the manipulation input function together. Here, the button may be various types of buttons such as a mechanical button, a touch pad, or a wheel formed at any area such as a front part, a side part, a rear part, or the like of an appearance of a body of the display device 100.

The microphone 160 is a configuration for receiving sound and converting the sound to an audio signal. The microphone 160 may be electrically connected to the processor 130 and receive sound under control of the processor 130.

For example, the microphone 160 may be formed as an integral type as being integrated into an upper side of the display device 100 or in a front direction, a side direction, or the like. Otherwise, the microphone 160 may be included in a remote controller separate from the display device 100. In this case, the remote controller may receive sound through the microphone 160 and may provide the received sound to the display device 100.

The microphone 160 may include various components such as a microphone collecting sound in an analog form, an amplifier circuit amplifying the collected sound, an A/D conversion circuit sampling and converting the amplified sound to a digital signal, and a filter circuit removing a noise component from the converted digital signal.

Meanwhile, the microphone 160 may be implemented in a form of a sound sensor, wherein any type of configuration is proper if the configuration may collect sound.

The speaker 170 is a component outputting not only various audio data processed in the processor 130 but also various alarm sound, voice messages, or the like.

The camera 180 is a component for capturing a static image or a moving image. The camera 180 may capture a static image of a specific time point but may successively capture the static image.

The camera 180 includes a lens, a shutter, an aperture, a solid-state imaging element, an analog front end (AFE), and a Timing Generator (TG). The shutter controls a time when light reflected from a subject enters into the camera 180, and the aperture controls an amount of light incident on the lens by mechanically increasing or reducing a size of an opening through which light enters. The solid-state imaging element, if light reflected from the subject is accumulated as a photo charge, outputs a pattern resulting from the photo charge as an electric signal. The TG outputs a timing signal for readoutting on pixel data of the solid-state imaging element, and the AFE samples and digitalizes the electric signal outputted from the solid-state imaging element.

As above, the display device 100 may improve metamerism thanks to performing calibration based on the measurement value of the second display device 200. Also, in spite of using the measuring instrument of the legacy CMF, the display device (100) may obtain a measurement value of the CMF which is more proper to the display device 100, and even if the display device 100 is in a wide color gamut, substantial calibration is possible with the existing measuring instrument.

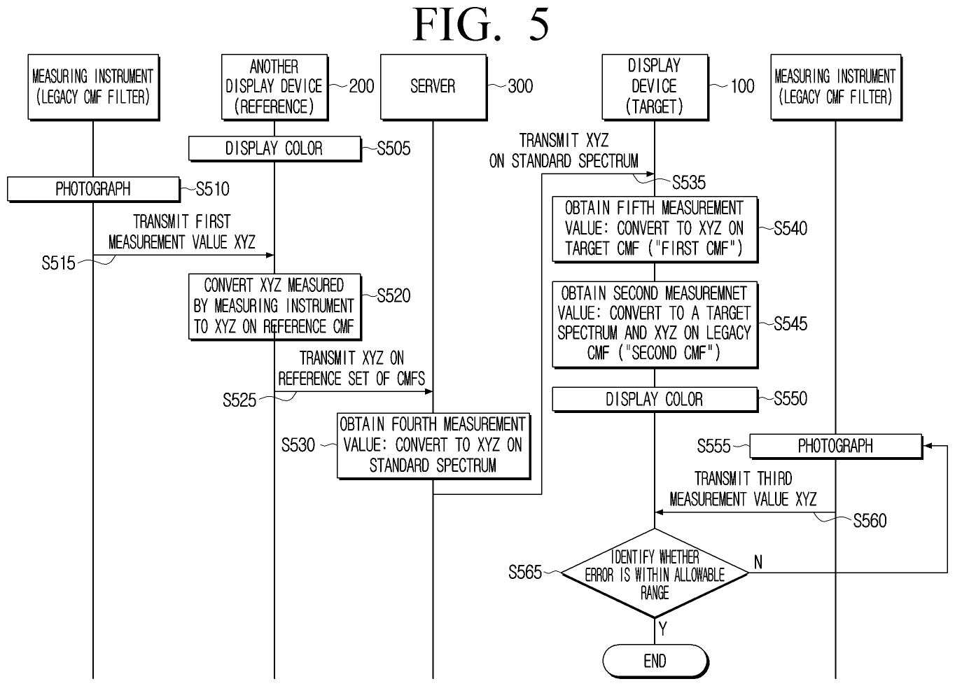

Hereinafter, operations of the display device 100 are more specifically described with reference to FIGS. 5 to 15. In FIGS. 5 to 15, individual examples are described for convenience of the description. Meanwhile, the individual examples of FIGS. 5 to 15 may be implemented in any combined state.

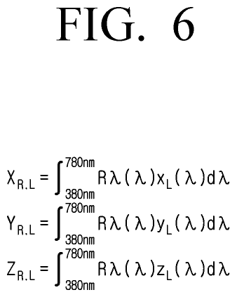

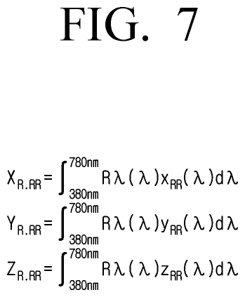

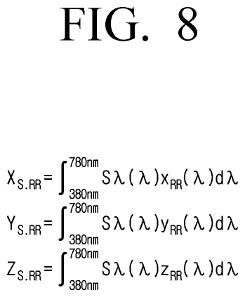

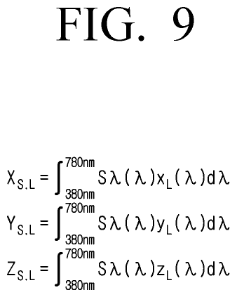

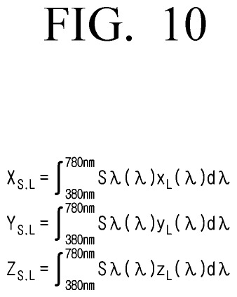

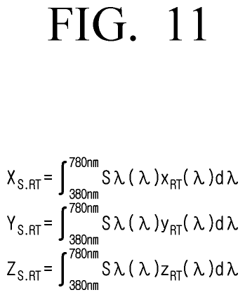

FIG. 5 is a sequence diagram illustrating a method of transmitting a measurement value according to an embodiment. In FIG. 5, each process where the measurement value is converted is additionally described through FIGS. 6 to 13.

In advance, second display device 200 may display a preset color (S505). A measuring instrument of a legacy CMF may photograph the preset color displayed on the second display device 200 (S510) and transmit a first measurement value XYZ to the second display device 200 (S515). Here, the measuring instrument of the legacy CMF may be a measuring instrument using a CIE 1931 measurement method.

The first measurement value XYZ may be expressed as shown in FIG. 6. For example, in FIG. 6, X_{R,L},Y_{R,L},Z_{R,L} represents a first measurement value, Rλ represents a reference spectrum corresponding to the second display device 200, and x_{L},y_{L},z_{L} represents a legacy CMF. That is, the measurement value may be theoretically a value of integration of multiplication of the spectrum and the CMF.

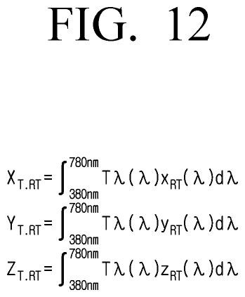

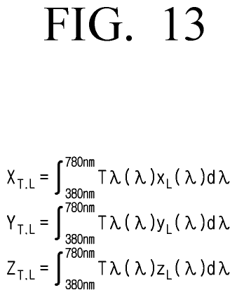

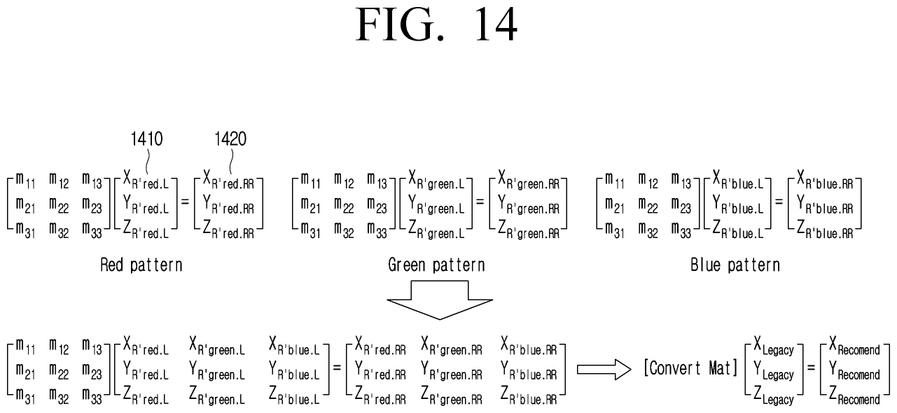

The second display device 200 may convert the first measurement value XYZ to XYZ on a reference CMF corresponding to the second display device 200 (S520). For example, the second display device 200 may convert the first measurement value XYZ to XYZ on the reference CMF corresponding to the second display device 200 through a conversion matrix. Here, the reference CMF may be a CMF optimized to the second display device 200. The conversion matrix is a preobtained matrix, wherein a method of obtaining the conversion matrix is described through FIG. 14.

XYZ on the reference CMF may be expressed as shown in FIG. 7. For example, in FIG. 7, X_{R,RR},Y_{R,RR},Z_{R,RR} represents XYZ on the reference CMF, Rλ represents a reference spectrum corresponding to the second display device 200, and x_{RR},y_{RR},z_{RR} represents the reference CMF.

The second display device 200 may transmit XYZ on the reference CMF to a server 300 (S525), and the server 300 may convert XYZ on the reference CMF to XYZ on the standard spectrum (identical to the fourth measurement value) (S530). That is, the converted XYZ may be XYZ converted to the legacy CMF on the standard spectrum.

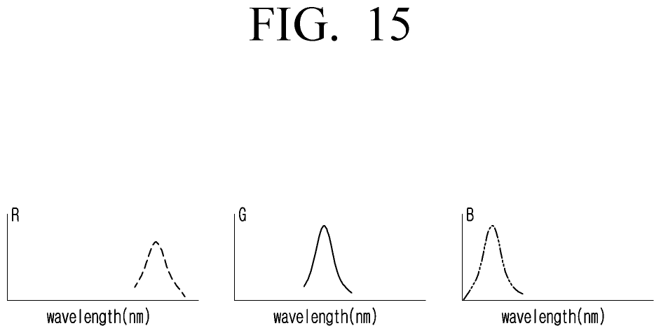

For example, the server 300 may obtain a RGB combination ratio of the standard spectrum from XYZ on the reference CMF. This operation may be expressed as shown in FIG. 8, for example, in FIG. 8, X_{S,RR},Y_{S,RR},Z_{S,RR} may be the same as X_{R,RR},Y_{R,RR},Z_{R,RR} of FIG. 7, Sλ may be a standard spectrum, and x_{RR},y_{RR},z_{RR} may be a reference CMF. Here, the standard spectrum includes pattern R, pattern G, and pattern B, and the server 300 may prestore pattern R, pattern G, and pattern B of the standard spectrum. The server 300 may obtain a RGB combination ratio of the standard spectrum satisfying X_{S,RR},Y_{S,RR},Z_{S,RR} by using the reference CMF. A method of obtaining the RGB combination ratio of the standard spectrum is described in FIG. 15.

The server 300, if the RGB combination ratio of the standard spectrum is obtained, may obtain XYZ on the standard spectrum based on the legacy CMF. This operation may be expressed as shown in FIG. 9, for example, in FIG. 9, X_{S,L},Y_{S,L},Z_{S,L} may be the same as XYZ on the standard spectrum, SA may be a standard spectrum, and x_{L},y_{L},z_{L} may be a legacy CMF. The server 300 may prestore pattern R, pattern G, and pattern B of the standard spectrum, and the legacy CMF and perform integration such as FIG. 9 by using a RGB combination ratio of the obtained standard spectrum to obtain XYZ converted to the legacy CMF on the standard spectrum.

The server 300 may transmit XYZ on the standard spectrum to the display device 100 (S535), and the display device 100 may convert XYZ on the standard spectrum to XYZ on the target CMF (identical to the fifth measurement value) (S540).

For example, the display device 100 may obtain a RGB combination ratio of the standard spectrum from XYZ on the standard spectrum. This operation may be expressed in FIG. 10, for example, in FIG. 10, X_{S,L},Y_{S,L},Z_{S,L} may be the same as XYZ on the standard spectrum, Sλ may be a standard spectrum, and x_{L},y_{L},z_{L} may be the legacy CMF. The display device 100 may prestore pattern R, pattern G, and pattern B of the standard spectrum, and the legacy CMF and may obtain a RGB combination ratio of the standard spectrum satisfying X_{S,L},Y_{S,L},Z_{S,L} by using the legacy CMF. A method of obtaining the RGB combination ratio of the standard spectrum is the same as the aforementioned method of obtaining the RGB combination ratio of the standard spectrum.

The display device 100 may obtain XYZ on the target CMF based on the target CMF based on the RGB combination ratio of the standard spectrum. This operation may be expressed as shown in FIG. 11, for example, in FIG. 11, X_{S,RT},Y_{S,RT},Z_{S,RT} may represent XYZ on the target CMF, Sλ may be a standard spectrum, and x_{RT},y_{RT},z_{RT} may be a target CMF. The display device 100 may prestore pattern R, pattern G, and pattern B of the standard spectrum, and the legacy CMF and perform integration such as FIG. 11 by using a RGB combination ratio of the obtained standard spectrum to obtain XYZ on the target CMF. Here, the target CMF may be a CMF optimized to the display 120.

The display device 100 may obtain a target spectrum and XYZ on the legacy CMF (identical to the second measurement value) from XYZ on the target CMF (S545).

For example, the display device 100 may obtain a RGB combination ratio of the target spectrum from XYZ on the target CMF. This operation may be expressed as shown in FIG. 12, for example, in FIG. 12, X_{T,RT},Y_{T,RT},Z_{T,RT} may be the same as X_{S,RT},Y_{S,RT},Z_{S,RT} of FIG. 11, Tλ may be a target spectrum, and x_{RT},y_{RT},z_{RT} may be a target CMF. Here, the target spectrum includes pattern R, pattern G, and pattern B, and the display device 100 may prestore pattern R, pattern G, and pattern B of the target spectrum. The display device 100 may obtain a RGB combination ratio of the target spectrum satisfying X_{T,RT},Y_{T,RT},Z_{T,RT} by using the target CMF. A method of obtaining the RGB combination ratio of the target spectrum is the same as the method of obtaining the RGB combination ratio of the standard spectrum.

The display device 100, if the RGB combination ratio of the target spectrum is obtained, may obtain the target spectrum and XYZ on the legacy CMF based on the legacy CMF. This operation may be expressed as shown in FIG. 13, for example, in FIG. 13, X_{T,L},Y_{T,L},Z_{T,L} may represent the target spectrum and XYZ on the legacy CMF, Tλ may be a target spectrum, and x_{L},y_{L},z_{L} may be a legacy CMF. The display device 100 may prestore pattern R, pattern G, and pattern B of the target spectrum, and the legacy CMF and perform integration such as FIG. 13 by using a RGB combination ratio of the obtained target spectrum to obtain a target spectrum and XYZ on the legacy CMF.

The display device 100 may display a preset color (S550). Here, the preset color may be the same as a color displayed on the second display device 200. A measuring instrument of a legacy CMF may photograph the preset color displayed on the display device 100 (S555) and transmit a third measurement value XYZ to the display device 100 (S560).

The display device 100 may identify whether a difference between the second measurement value and the third measurement value is within the preset value (S565). For example, the display device 100, if a difference between the second measurement value and the third measurement value is equal to or greater than a preset value, may perform the calibration based on the second measurement value and the third measurement value, and if the difference between the second measurement value and the third measurement value is less than the preset value, terminate the calibration.

It is illustrated in FIG. 5 that the second display device 200 is separate from the server 300, but the disclosure is not limited thereto. For example, the second display device 200 may perform operations of the server 300.

Also, it is illustrated in FIG. 5 that the server 300 transmits XYZ on the standard spectrum to the display device 100, but the disclosure is not limited thereto. For example, the server 300, after obtaining the RGB combination ratio of the standard spectrum, may not obtain XYZ on the standard spectrum but transmit the RGB combination ratio of the standard spectrum to the display device 100. In this case, the display device 100 may obtain the target spectrum and XYZ on the legacy CMF through the aforementioned operation based on the RGB combination ratio of the standard spectrum.

FIG. 14 is a view illustrating a method of obtaining a conversion matrix according to an embodiment.

The second display device 200 may convert the first measurement value XYZ to XYZ on the reference CMF corresponding to the second display device 200 through a conversion matrix. Here, the first measurement value XYZ is a value measured by the measuring instrument of the legacy CMF. That is, the conversion matrix may be a matrix for converting XYZ on the legacy CMF to XYZ on the reference CMF.

For the above, as shown in FIG. 14, an equation may be configured from each of pattern R, pattern G, and pattern B as shown in FIG. 14.

The second display device 200 may be in a state of storing information about a reference spectrum, a legacy CMF, and a reference CMF, obtain X_{R′red,L}Y_{R′red,L},Z_{R′red,L} 1410 from an equation of the pattern R of FIG. 14 based on the reference spectrum and the legacy CMF, and obtain X_{R′red,RR}Y_{R′red,RR},Z_{R′red,RR} 1420 from an equation of the pattern R of FIG. 14 based on the reference spectrum and the reference CMF. The second display device 200 may obtain an equation of the pattern G and an equation of pattern B in the same way and may obtain a conversion matrix (m₁₁, . . . , m₃₃, Convert Mat) through nine equations with respect to nine variables.

It is illustrated in FIG. 14 that X_{R′red,L}Y_{R′red,L},Z_{R′red,L} 1410 is obtained based on the reference spectrum and the legacy CMF, but the disclosure is not limited thereto. For example, X_{R′red,L}Y_{R′red,L},Z_{R′red,L} 1410 may be obtained in a method that the second display device 200 displays pattern R, and the measuring instrument of the legacy CMF measures the same.

FIG. 15 is a view illustrating a method of obtaining a RGB combination ratio of a standard spectrum according to an embodiment.

In advance, a target x coordinate is defined as Targetx, a target y coordinate is defined as Targety, target luminance is defined as TargetYY, a coordinate of a red light spectrum is defined as Rx, Ry luminance is defined as rYY, a coordinate of a green light spectrum is defined as Gx, Gy luminance is defined as GYY, a coordinate of a blue light spectrum is defined as Bx, and By luminance is defined as BYY, wherein det, tempX, tempY, TempYY, tempZ, RZ, GZ, and BZ may be defined as temporary storage variables. Here, Targetx=X/(X+Y+Z), and a target y coordinate Targety=Y/(X+Y+Z), and target luminance TargetYY=Y.

In this case, the RGB combination ratio of the standard spectrum may be obtained as shown in FIG. 15 through a mathematical equation as below.

$$tempX = Rx : tempY = Ry : TempYY = rYY$$

$$Rx = tempX \times TempYY / tempY : Ry = TempYY : RZ = TempYY / tempY \times ( 1 - tempX - tempY )$$

$$tempX = Gx : tempY = Gy : TempYY = GYY$$

$$Gx = tempX \times TempYY / tempY : Gy = TempYY : GZ = TempYY / tempY \times ( 1 - tempX - tempY )$$

$$tempX = Bx : tempY = By : TempYY = BYY$$

$$Bx = tempX \times TempYY / tempY : By = TempYY : BZ = TempYY / tempY \times ( 1 - tempX - tempY )$$

$$tempX = Targetx \times TargetYY / Targety : tempY = TargetYY : tempZ = TargetYY / Targety \times ( 1 - Targetx - Targety )$$

$$det = Rx \times ( Gy \times BZ - By \times GZ ) + Gx \times ( By \times RZ - Ry \times BZ ) + Bx \times ( Ry \times GZ - Gy \times RZ )$$

$$RED spectrum luminance ratio = ( tempX \times ( Gy \times BZ - By \times GZ ) - tempY \times ( Gx \times BZ - Bx \times GZ ) + tempZ \times ( Gx \times By - Bx \times Gy ) ) / det$$

$$GREEN spectrum luminance ratio = ( tempX \times ( By \times RZ - Ry \times BZ ) - tempY \times ( Bx \times RZ - Rx \times BZ ) + tempZ \times ( Bx \times Ry - Rx \times By ) ) / det$$

$$BLUE spectrum luminance ratio = ( tempX \times ( Ry \times GZ - Gy \times RZ ) - tempY \times ( Rx \times GZ - Gx \times RZ ) + tempZ \times ( Rx \times Gy - Gx \times Ry ) ) / det$$

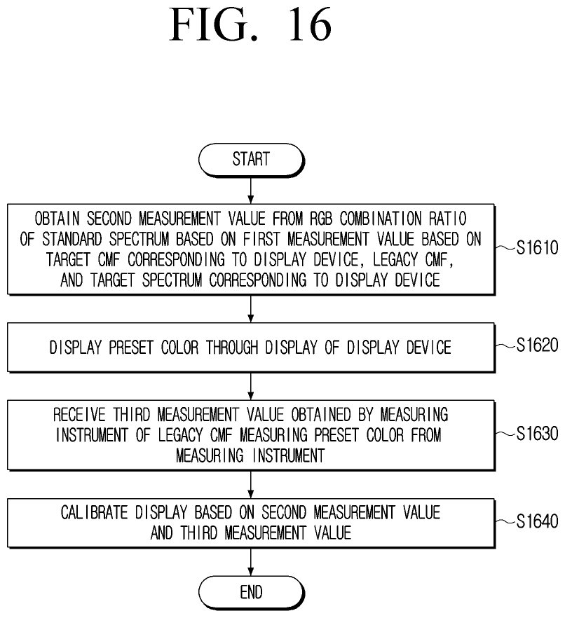

FIG. 16 is a flow chart illustrating a method of controlling a display device according to an embodiment.

In advance, the method includes obtaining a second measurement value from a RGB combination ratio of a standard spectrum based on a first measurement value based on a target CMF corresponding to the display device, a legacy CMF, and a target spectrum corresponding to the display device (S1610). Further, the method includes displaying a preset color though a display of the display device (S1620). Further, the method includes receiving a third measurement value obtained by a measuring instrument of the legacy CMF measuring the preset color from the measuring instrument (S1630). Still further, the method includes calibrating the display based on the second measurement value and the third measurement value (S1640). Here, the first measurement value may be a value obtained by the measuring instrument of the legacy CMF measuring the preset color displayed on the second display device.

Also, the calibrating (S1640) may include, if a difference between the second measurement value and the third measurement value is equal to or greater than a preset value, performing the calibration based on the second measurement value and the third measurement value, and if the difference between the second measurement value and the third measurement value is less than the preset value, terminating the calibration.

Further, the method may further include repeating the calibration based a plurality of preset colors.

Also, the RGB combination ratio of the standard spectrum may be obtained from the first measurement value based on the reference CMF corresponding to the second display device and the standard spectrum.

Further, the method may further include receiving a fourth measurement value based on the first measurement value from the second display device or a server and obtaining a RGB combination ratio of the standard spectrum based on the fourth measurement value and the legacy CMF.

Also, the fourth measurement value may be obtained based on the RGB combination ratio of the standard spectrum and the legacy CMF.

Further, the method may further include receiving the RGB combination ratio of the standard spectrum from the second display device or a server.

Also, the obtaining the second measurement value (S1610) may include obtaining a fifth measurement value based on the RGB combination ratio of the standard spectrum and the target CMF, obtaining a RGB combination ratio of the target spectrum based on the fifth measurement value and the target spectrum, and obtaining the second measurement value based on the RGB combination ratio of the target spectrum and the legacy CMF.

Further, the measuring instrument of the legacy CMF may be a measuring instrument using a CIE 1931 measurement method.

Also, a standard spectrum may have a color gamut wider than that of a target spectrum.

According to various embodiments of the disclosure as above, the display device may improve metamerism thanks to performing calibration based on the measurement value of the second display device.

Also, in spite of using the measuring instrument of the legacy CMF, it may obtain a measurement value of the CMF which is more proper to the display device, and in spite of using the display device being in a wide color gamut, substantial calibration is possible with the existing measuring instrument.

Meanwhile, in the standard spectrum used above, a virtual value may be used rather than a real measurement value of a light source.

Also, information stored in the display device, the second display device, and the server may be received from a separate external server or may be shared between each device.

Further, if there is no information about a target CMF in a process of converting a measurement value, conversion may be performed based on a legacy CMF.

Meanwhile, if at least one of the display device or the second display device does not include an operation device, memory, or the like, it may be connected to a desktop PC, or the like, and an external operation device such as the desktop PC may perform an conversion operation.

Further, it was described that each of the display device and the second display device is separate from the measuring instrument, but the disclosure is not limited thereto. For example, at least one of the display device or the second display device may be implemented as one device including the measuring instrument. Also, at least one of the display device or the second display device may include a camera, wherein the camera may be used as a measuring instrument. Here, the camera may be in a state of being wirelessly connected to at least one of the display device or the second display device.

Meanwhile, according to an embodiment of the disclosure, various examples described above may be implemented as software including instructions stored in machine (e.g. a computer) readable storage media. The machine refers to a device which calls instructions stored in the storage media and is operable according to the called instructions, wherein the machine may include an electronic device (e.g. an electronic device A) according to the disclosed embodiments. If the instructions are executed by a processor, the processor may perform a function corresponding to the instructions directly or by using other components under control of the processor. The instructions may include a code generated or executed by a compiler or an interpreter. A machine readable storage medium may be provided in a form of a non-transitory storage medium. Here, the term ‘non-transitory’ merely means that the storage media do not include a signal and are tangible, wherein the term does not distinguish a case that data is stored in the storage media semipermanently from a case that data is stored in the storage media temporarily.

Also, according to an embodiment of the disclosure, the method according to various examples described above may be provided to be included in a computer program product. The computer program product may be traded between a seller and a buyer as goods. The computer program product may be distributed in a form of a machine readable storage medium (e.g. compact disc read only memory (CD-ROM)) or on-line via an application store (e.g. Play Store™). In the case of on-line distribution, at least part of the computer program product may be stored at least temporarily or may be generated temporarily in a storage medium such as memory of a server of a manufacturer, a server of an application store, or a relay server.

Also, according to an embodiment of the disclosure, various embodiments described as above may be implemented in a recording medium that may be read by a computer or a device similar thereto by using software, hardware, or a combination thereof. In some cases, embodiments described in the specification may be implemented as a processor itself. According to software implementation, embodiments such as procedures and functions described in the specification may be also implemented as separate software. Each software may perform one or more functions and operations described in the specification.

Meanwhile, computer instructions for performing the processing operation of the machine according to the various embodiments above may be stored in a non-transitory computer readable medium. Computer instructions stored in this non-transitory computer readable medium that, when executed by a processor of a specific device, causes the specific device to perform a processing operation of the device according to the various embodiments. The non-transitory computer readable medium does not mean a medium that stores data for a short time such as a resistor, a cache, memory, or the like but a machine readable medium that stores data semipermanently. A specific example of the non-transitory computer readable medium may be a CD, a DVD, a hard disk, a Blu-ray disk, a USB, a memory card, ROM, etc.

Also, each of components (e.g. a module or a program) according to the various embodiments above may be configured as a single item or a plurality of items, wherein a partial subcomponent of the aforementioned relevant subcomponents may be omitted, or another subcomponent may be further included in various embodiments. Mostly or additionally, some components (e.g. a module or a program) may be integrated into one item and may identically or similarly perform a function implemented by each of the relevant components before the integration. According to various embodiments, operations performed by a module, a program, or another component may be executed sequentially, in parallel, repetitively, or heuristically, or at least part of the operations may be executed in different orders or be omitted, or another operation may be added.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. A display device, comprising:
a communication interface;
a display; and
at least one processor connected to the communication interface and the display, and configured to control the display device,
wherein the at least one processor is configured to:
based on a first color matching function (CMF) corresponding to the display device, a second CMF, and a target spectrum corresponding to the display device, obtain a second measurement value from a RGB combination ratio of a standard spectrum based on a first measurement value;
control the display to display a preset color;
receive a third measurement value from a measuring instrument of the second CMF for the preset color through the communication interface; and
calibrate the display based on the second measurement value and the third measurement value, and
wherein the first measurement value is a value for the preset color displayed on a second display device.

2. The display device of claim 1, wherein the at least one processor is further configured to:
based on a difference between the second measurement value and the third measurement value being equal to or greater than a preset value, perform the calibration based on the second measurement value and the third measurement value; and
based on the difference between the second measurement value and the third measurement value being less than the preset value, terminate the calibration.

3. The display device of claim 1, wherein the at least one processor is further configured to:
repeat the calibration based on a plurality of preset colors.

4. The display device of claim 1, wherein the RGB combination ratio of the standard spectrum is based on the first measurement value, a third CMF corresponding to the second display device, and the standard spectrum.

5. The display device of claim 1, wherein the at least one processor is further configured to:
receive a fourth measurement value based on the first measurement value from the second display device or a server through the communication interface; and
obtain a RGB combination ratio of the standard spectrum based on the fourth measurement value and the second CMF.

6. The display device of claim 5, wherein the fourth measurement value is based on the RGB combination ratio of the standard spectrum and the second CMF.

7. The display device of claim 1, wherein the at least one processor is further configured to:
receive a RGB combination ratio of the standard spectrum from the second display device or a server through the communication interface.

8. The display device of claim 1, wherein the at least one processor is further configured to:
obtain a fifth measurement value based on the RGB combination ratio of the standard spectrum and the first CMF;
obtain a RGB combination ratio of the target spectrum based on the fifth measurement value and the target spectrum; and
obtain the second measurement value based on the RGB combination ratio of the target spectrum and the second CMF.

9. The display device of claim 1, wherein the measuring instrument of the second CMF is based on a Commission Internationale de l'Eclairage (CIE) 1931 measurement method.

10. The display device of claim 1, wherein the standard spectrum has a color gamut wider than a color gamut of the target spectrum.

11. A method of controlling a display device, comprising:
based on a first CMF corresponding to the display device, a second CMF, and a target spectrum corresponding to the display device, obtaining a second measurement value from a RGB combination ratio of a standard spectrum based on a first measurement value;
displaying a preset color though a display of the display device;
receiving a third measurement value from a measuring instrument of the second CMF for the preset color; and
calibrating the display based on the second measurement value and the third measurement value,
wherein the first measurement value is a value for the preset color displayed on a second display device.

12. The method of claim 11, wherein the calibrating comprises:
based on a difference between the second measurement value and the third measurement value being equal to or greater than a preset value, performing the calibration based on the second measurement value and the third measurement value; and
based on the difference between the second measurement value and the third measurement value being less than the preset value, terminating the calibration.

13. The method of claim 11, further comprising:
repeating the calibration based on a plurality of preset colors.

14. The method of claim 11, wherein the RGB combination ratio of the standard spectrum is based on the first measurement value, a third CMF corresponding to the second display device, and the standard spectrum.

15. The method of claim 11, further comprising:
receiving a fourth measurement value based on the first measurement value from the second display device or a server; and
obtaining a RGB combination ratio of the standard spectrum based on the fourth measurement value and the second CMF.
